(19) United States
(12) Patent Application Publication
(10) Pub. No.: US 2011/0303245 A1
(43) Pub. Date: Dec. 15, 2011

(54) HYDROJET CLEANER AND METHOD FOR CLEANING THE INTERIOR OF A COILED TUBULAR DEVICE

(76) Inventors: Manfred Heinrich Schmitz-Goeb, Gummersbach (DE); Tanja Schneider, Gummersbach (DE)

(21) Appl. No.: 13/148,337

(22) PCT Filed: Feb. 9, 2010
(86) PCT No.: PCT/EP2010/051551

§ 371 Date: Aug. 8, 2011

(30) Foreign Application Priority Data
Feb. 9, 2009 (EP) 09152367.0

(51) Int. Cl. B08B 9/049; B08B 3/02

(52) U.S. Cl. 134/22.12; 134/167 C

(57) ABSTRACT

A hydrojet cleaning device (1) for cleaning the interior of a curved or coiled tubular device comprising a flexible hose (3) having one end connectable to a supply of pressurized water, and one end provided with a jet nozzle (5). The flexible hose is provided with a plurality of circumferential spacers (6) distributed over at least a section of the length of the hose. The spacers can for example comprise pulleys (11). Method of cleaning a coiled tubular line, such as a spiralled heat exchanger using such a hydrojet cleaning device. The distance between the spacers may, e.g., be such that the section of the hose between the spacers is entirely spaced from the interior wall of the tubular line wall over its full length.

The present invention relates to a hydrojet or waterjet cleaning device particularly suitable for cleaning curved or coiled tubular devices, such as spiralled heat exchangers.

With hydrojet cleaning high pressure streams of water are forced through a line or tube to remove scaling and fouling. Hydrojet cleaners for lines or tubes typically comprise a hose having one end connectable to a pressurized water supply and one end provided with a nozzle. An example of a hydrojet cleaner is disclosed in DE 196 20 783 A1, disclosing a hydrojet cleaner with a nozzle having four sliders.

A typical example of a spiral heat exchanger that requires regular descaling and cleaning is the type of spiral heat exchanger generally used in gasification processes for the production of syngas, such as for example described in WO-A-2007/131975. In such a process, carbonaceous feedstock is partially oxidised in a reactor. Syngas leaving the reactor typically has a temperature of 1300-1400° C. The hot syngas is transported to a spiral heat exchanger, generally consisting of a number of parallel helically coiled tubes submerged in water. The configuration of such a heat exchanger can be complicated and comprise 2-12 or more parallel helically wound tubes, which may have inner diameters varying over their length. The syngas is transported through the coiled tubes to dissipate heat via the tube walls to the water to generate steam.

The syngas flows through the heat exchanger tubes with a flow velocity sufficiently high to prevent accumulation of soot and ash, and sufficiently low to avoid erosion. To this end, the heat exchangers are generally designed to have a stepwise decreasing tube diameter over the length of the syngas flow path in the heat exchanger.

In such heat exchangers, fouling and scaling is not only caused by accumulation of inorganic deposits originating from ash and soot, but also occurs by sulphidation due to the presence of hydrogen sulphide.

Although fouling can be kept at an acceptable level with proper gas flow velocities, a gradual build up of fouling layers on the interior wall of the heat exchanger occurs during normal operation. The fouling reduces effective heat exchange resulting in a gradual increase of the temperature of syngas leaving the heat exchanger. After a certain time, the heat exchanger needs to be cleaned which requires complete shutdown of the gasification reactor.

Cleaning of spiral heat exchangers can for example be done by pigging, by chemical cleaning, such as pickling, or by hydrojetting. However, considering the helically coiled contour of the tubes, the hydrojet hose cannot be moved through the entire length of the syngas flow path. With the hydrojet nozzle moving forward the friction between the hose and the interior tube wall will increase and will finally be too large to move on or to move back. Consequently, in practice hydrojetting can only be used for the first few meters of the flow path in the heat exchanger.

It is an object of the invention to provide a hydrojet cleaning apparatus which can be used for cleaning curved, e.g., coiled or spiralled tubular devices, such as spiralled heat exchangers, over a longer flow path.

The object of the invention is achieved with a hydrojet cleaning device comprising a flexible hose having one end connectable to a supply of pressurized water, and one end provided with a jet nozzle wherein the flexible hose is provided with a plurality of circumferential spacers distributed over at least a section of the length of the hose, which allow the hose to be more easily inserted in and retracted from the heat exchanger or other curved or coiled tubular device to be cleaned. In this context, circumferential spacers means spacers spacing the hose over the full circumference of the hose.

The spacers can for example comprise two or more radial extensions, such as pulleys or gliders, extending radially from the hose. The radial extensions of a single spacer can for example take up the same axial position with respect to the hose. Alternatively, the spacer can comprise radial extensions which are staggered relative to each other in the axial direction of the hose. To minimize friction between the spacers and the interior tube wall, the spacers can for example comprise pulleys or wheels. The pulleys can for instance be made of a low friction material, such as a polyurethane or PTFE. The spacer can for example have 3-6 pulleys, e.g. 3 or 4 pulleys, which may for example be arranged equidistantly on the circumference of the hose. Alternatively, the spacers can be gliders, preferably having a minimized contact surface with the interior tube wall. Such gliders can also be made of a low friction material, such as PTFE or polyurethane. Combinations of gliders and pulleys can also be used.

The hose of the hydrojet cleaning device has one end connectable to a supply of pressurized water. This supply can for example be a high pressure pump delivering the water jet at about 500-1000 bar.

The hydrojet cleaning device of the present invention comprises a nozzle for jetting pressurized water against the interior tube wall. The nozzle can for example have forwardly directed openings for jetting pressurized water in a direction towards a part of the interior tube wall at a distance in front of the nozzle or radially next to the nozzle. The shorter the distance between nozzle opening and impingement point of the jet on the wall the better the cleaning effect generally is. Alternatively or additionally, the nozzle can have backwardly directed jet openings, for jetting water against the interior tube wall just behind the nozzle. This propels the nozzle forwardly, so the hydrojet device can drive itself through the tube.

The hydrojet cleaning device of the invention can be used for a method of cleaning a tubular line such as a curved or coiled tubular line, such as a spiralled heat exchanger, which can for example have an inner diameter which is reduced in a stepwise manner over the gas flow path. The distance between two subsequent spacers can be such that the section of the hose between the spacers is spaced from the interior line wall over the full length of the section, particularly when passing a curve of the flow path. The optimum distance between two subsequent spacers is dependent on the diameter of the hose, the diameter defined by the spacers, the interior diameter of the tube and the inner diameter of the curved or coiled flow path. For typical syngas coolers, having a coil diameter of about 1-2.5 m, a distance of 1 m or less, e.g. of 30-80 cm, should be sufficient.

The diameter defined by the outer points of a spacer should be slightly smaller than the inner diameter of the tube to be passed by that spacer. If the inner diameter of the spiralled tube is gradually or stepwise reduced along the flow path—as is for instance the case with after-coolers for gasification reactors—then the diameter defined by the outer points of a spacer should be slightly smaller than the smallest inner diameter of the tube to be passed by that spacer.

The invention is further explained under reference to the accompanying drawings. In the drawings:

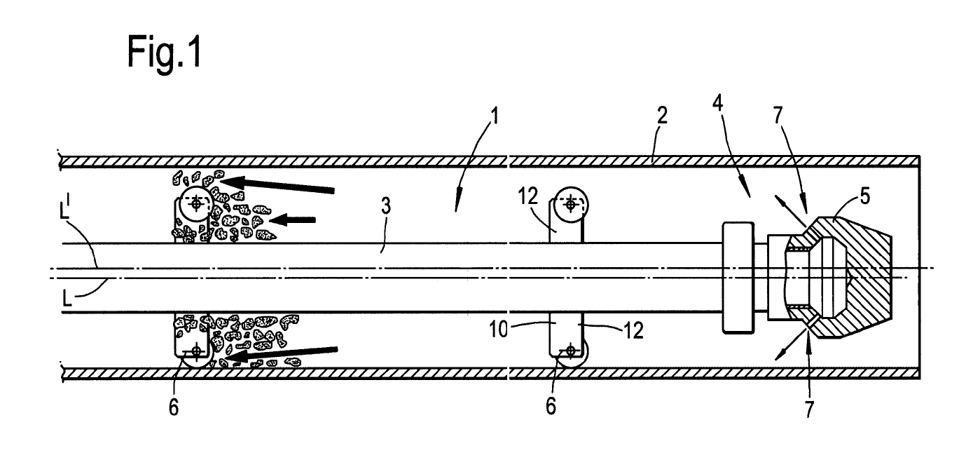

FIG. 1: shows a longitudinal cross section of a hydrojet cleaning device according to the present invention in a tube to be cleaned;

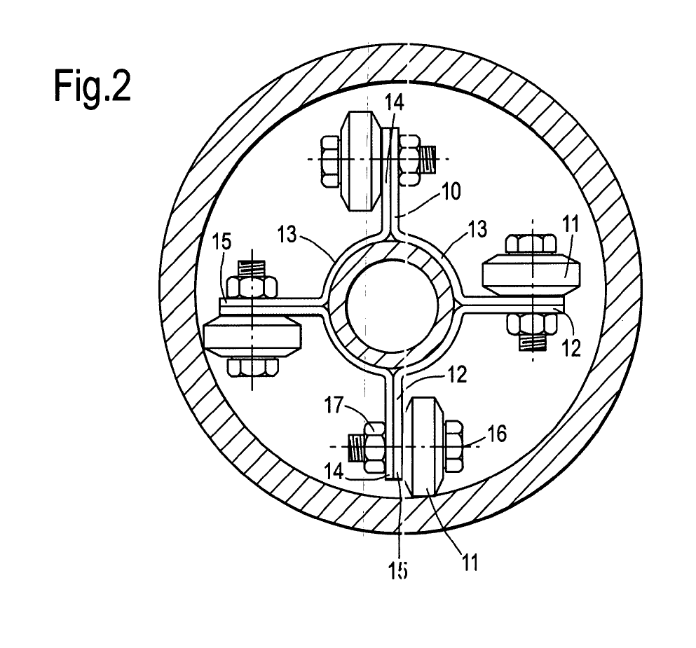

FIG. 2: shows a cross section of the hose and a spacer of the cleaning device of FIG. 1;

FIG. 1 shows a hydrojet cleaning device 1 according to the present invention positioned in a tubular channel 2, e.g., of a spiralled heat exchanger. The hydrojet cleaning device 1 comprises a flexible hose 3 having one end connectable to a supply of pressurized water, such as a high pressure pump (not shown) and one end 4 provided with a jet nozzle 5. The flexible hose 3 is provided with a plurality of circumferential spacers 6 distributed over at least a section of the length of the hose 3.

The nozzle 5 comprises a number of openings 7 for jetting pressurized water against the interior wall of the tubular channel 2. In the drawing, the openings are directed backwardly, jetting water in the direction indicated in the drawing with arrows A. Optionally, the nozzle 5 can also comprise openings directed to a part of the interior wall of tubular channel 2 in front of the nozzle 5 or radially next to the nozzle. The backwardly jetted water drives the nozzle 5 with the hose 3 forward through the tubular channel 2.

FIG. 2 shows one possible embodiment of the spacer. The spacers 6 comprise a holder 10 holding four pulleys 11, as shown in FIG. 2. The holder 10 comprises four sheet metal sections 12 comprising a quarter circular segment 13 having a radially extending flange 14, 15 at both ends. The flanges 14, 15 of two adjacent sections 12 are crossed by a bolt 16 rotatably bearing a pulley 11 and fixated by a nut 17.

Other configurations, especially concerning the number of pulleys, the detail design of the holder 10, the fixation of the pulleys or even gliders instead of wheels are possible.

The distance between the centre of the hose 3 and the outer point of the pulley 11 is less than the inner diameter of the tubular channel 2. As a result, the centre line L of the hose 3 is offset from the centre line L′ of the tubular channel 2. This way, the spacers can enter a next section of the tubular channel 2 which may have a smaller diameter, as is for instance the case in spiralled heat exchangers used with gasification reactors for the production of syngas.

1. A hydrojet cleaning device for cleaning the interior of a curved or coiled tubular device comprising a flexible hose having one end connectable to a supply of pressurized water, and one end provided with a jet nozzle wherein the flexible hose is provided with a plurality of circumferential spacers distributed over at least a section of the length of the hose.

2. A hydrojet cleaning device according to claim 1 wherein the spacers comprise at least two radial extensions extending radially from the hose.

3. A hydrojet cleaning device according to claim 2 wherein the radial extensions of a spacer take up the same axial position with respect to the hose.

4. A hydrojet cleaning device according to claim 2 wherein at least a part of the radial extensions are pulleys.

5. A hydrojet cleaning device according to claim 4 wherein at least a part of the pulleys is made of a low friction material.

6. A hydrojet cleaning device according to claim 1 wherein the distance between the circumferential spacers is 30-80 cm.

7. A method of cleaning a tubular line comprising inserting a hydrojet cleaning device according to claim 1 into a tubular line.

8. A method according to claim 7 wherein the tubular line comprises a plurality of curves and wherein the distance between the spacers is such that the section of the hose between the spacers is spaced from the interior line wall over its full length.

9. A method according to claim 7 wherein the tubular line has an inner diameter which is reduced in a stepwise manner along the length of the line and wherein at least the spacers directly following the nozzle define an outer diameter which is smaller than the smallest inner diameter of the tubular line.

10. A hydrojet cleaning device according to claim 4 wherein at least a part of the pulleys is made of polyurethane.
